(19) United States
(12) Patent Application Publication
(10) Pub. No.: US 2026/0249521 A1
(43) Pub. Date: Aug. 27, 2026

(54) COATING LAYER COMPOSITION FOR INJECTION MOLD AND INJECTION MOLD COMPRISING THE SAME

(71) Applicants: Hyundai Motor Company, Seoul (KR); Kia Corporation, Seoul (KR); LG CHEM, LTD., Seoul (KR); TEXONE CO., LTD, Hwaseong-si (KR)

(72) Inventors: Dae Sik Kim, Hwaseong-si (KR); Myoung Ryoul Lee, Hwaseong-si (KR); Hanki Lee, Hwaseong-si (KR); Mungyu Bak, Hwaseong-si (KR); Donguk Lee, Hwaseong-si (KR); Bo Min Kim, Hwaseong-si (KR); Sang Beom Jeon, Pyeongtaek-si (KR); In Ki Min, Hwaseong-si (KR); Woo Young Park, Daejeon (KR)

(73) Assignees: Hyundai Motor Company, Seoul (KR); Kia Corporation, Seoul (KR); LG CHEM, LTD., Seoul (KR); TEXONE CO., LTD, Hwaseong-si (KR)

(21) Appl. No.: 19/253,203

(22) Filed: Jun. 27, 2025

(30) Foreign Application Priority Data
Feb. 27, 2025 (KR) 10-2025-0025487

(51) Int. Cl. B29C 33/56; B29C 45/00; C08K 7/18; C09D 5/18; C09D 7/40; C09D 7/42; C09D 7/61; C09D 127/18

(52) U.S. Cl. CPC B29C 33/56; B29C 45/0025; C09D 5/18; C09D 7/42; C09D 7/61; C09D 7/69; C09D 7/70; C09D 127/18; C08K 7/18; C08K 2201/005

(57) ABSTRACT

The present disclosure relates to a coating layer composition for an injection mold having high heat resistance and an injection mold comprising the same.

### CROSS-REFERENCE TO RELATED APPLICATION

This present application claims the benefit and priority to Korean Patent Application No. 10-2025-0025487, which was filed on Feb. 27, 2025, in the Korean Intellectual Property Office, the entire disclosure of which is incorporated herein by reference in its entirety.

### FIELD

The present disclosure relates to a coating layer composition for an injection mold having high heat resistance and an injection mold comprising the same.

### BACKGROUND

Plastic injection molding is a processing method that involves melting plastic materials, injecting them into precision-engineered molds, and subsequently solidifying them to achieve specific shapes. As one of the most extensively utilized methods for producing plastic products, it has a role across various industries, including automotive, consumer goods, and medical devices. Despite its ubiquity and efficiency, the injection molding process is susceptible to a range of defects on the mold surface, which can stem from the inherent characteristics of the plastic materials, variations in processing conditions, and the intricacies of the product design. Common defects such as gas marks, flow marks, and surface blemishes can detrimentally impact both the aesthetic and functional quality of the final product.

These injection molding techniques can be used to produce high-quality surfaces in applications such as automotive interior components. In this context, the use of embossing on the mold surface allows for intricate textures and designs to be imparted onto the injection-molded product, thereby significantly enhancing its visual appeal. However, the introduction of embossing with specific depths, sizes, and shapes may inadvertently lead to defects not only on the mold surface but also on the resulting product's surface. Consequently, post-processing measures aimed at rectifying these mold surface imperfections are important, as they can result in both economic costs and time inefficiencies. Thus, there is a need to develop compositions and methods that minimize mold surface defects across repeated injection cycles to improve the quality of injection-molded components and align with the standards in the automotive industry.

The matters described in this Background section are only for enhancement of understanding of the background of the disclosure, and should not be taken as acknowledgement that they correspond to prior art already known to those skilled in the art.

### SUMMARY

The following summary presents a simplified summary of certain features. The summary is not an extensive overview and is not intended to identify key or critical elements.

The present disclosure provides a coating layer composition for an injection mold having high heat resistance and improved lifespan characteristics, and an injection mold comprising a coating layer comprising the same.

A coating layer composition for an injection mold according to an embodiment of the present disclosure includes a high-heat-resistant resin and a matting agent with no wax coating.

An injection mold according to an embodiment of the present disclosure includes a cavity area and a coating layer including the coating layer composition for an injection mold according to various embodiments of the present disclosure, wherein the coating layer is formed to cover at least a portion of the cavity area.

When including the coating layer composition for an injection mold according to the present disclosure, the coating layer of the injection mold, in embodiments, does not peel off even after repeated injection processes, resulting in improved lifespan characteristics.

In addition, the coating layer composition, in embodiments, possesses a high heat resistance, enabling operation even in high-temperature environments.

When using the injection mold according to the present disclosure, injection processes are performed, in embodiments, not only for polypropylene, but also for various high heat-resistant engineering plastics.

Injection-molded products thus produced, in embodiments, have a gloss of 1.5 or less as measured by a 60° gloss meter, enabling lower gloss implementation and adjustment compared to existing injection-molded products.

### BRIEF DESCRIPTION OF THE DRAWINGS

The foregoing and other aspects, features, and advantages, as well as the following detailed description of the embodiments, will be better understood when read in conjunction with the accompanying drawings. However, the present disclosure is not intended to be limited to the details shown in the drawings, and various modifications and structural changes may be made therein without departing from the spirit of the present disclosure and within the scope and range of equivalents of the claims. Like reference numbers and designations in the various drawings indicate like elements.

FIG. 1 is an image showing an appearance of an injection mold of Comparative Example 1 after repeated injections according to Experimental Example 1.

FIG. 2 is an image showing an appearance of an injection mold of Example 1 after repeated injections according to Experimental Example 1.

FIG. 3 shows images of an injection-molded product according to Experimental Example 2.

FIG. 4 shows images of an injection-molded product according to Experimental Example 2.

FIG. 5 shows images of an injection-molded product according to Experimental Example 2.

FIG. 6 shows images of an injection-molded product according to Experimental Example 2.

### DETAILED DESCRIPTION

Unless otherwise defined, all terms (including technical and scientific terms) used herein as is customary in the art to which the inventive concept of the present disclosure belongs. It will be further understood that terms in common usage should also be interpreted as is customary in the relevant art and not in an idealized or overly formal sense unless expressly so defined herein.

It will be understood that, although the terms “first,” “second,” and other numerical terms may be used herein to describe various elements, these elements should not be limited by these terms. These terms are only used to distinguish one element from another. For example, a first element could be termed a second element, and, similarly, a second element could be termed a first element, without departing from the scope of the present disclosure.

The terminology used herein is used for the purpose of describing particular exemplary embodiments only and is not intended to be limiting. As used herein, the articles “a,” “an,” and “the,” include plural referents unless the context clearly dictates otherwise. In the following disclosure, the terms “include,” “comprise,” “have,” and the like designate the existence of features, steps, elements, and combinations thereof, but should not be understood as precluding the existence or addition of one or more other features, steps, elements, and combinations thereof.

A coating layer composition for an injection mold according to the present disclosure, in embodiments, comprises a high-heat-resistant resin and a matting agent with no wax coating.

The coating layer composition of the present disclosure, in embodiments, comprises a high-heat-resistant resin to enable operation even in high-temperature environments. In the present disclosure, the high-heat-resistant resin, in embodiments, comprises polytetrafluoroethylene (PTFE) or polyetheretherketone (PEEK).

The coating layer composition according to the present disclosure, in embodiments, comprises a matting agent to adjust gloss and improve workability. In the present disclosure, the matting agent, in embodiments, is a matting agent that is not coated with wax.

The matting agent, in embodiments, comprises at least one inorganic matting agent selected from silica (SiO₂), magnesium oxide (MgO), zirconia (ZrO₂), alumina (Al₂O₃), and titania (TiO₂), or at least one organic matting agent selected from acrylic resin, epoxy resin, urethane resin, polyethylene resin, and polytetrafluoroethylene resin.

In embodiments, the matting agent comprises silica (SiO₂). In embodiments, the matting agent comprises spherical silica (SiO₂) with a particle diameter of 7 to 15 μm.

The coating layer composition of the present disclosure, in embodiments, comprises a strong matting effect due to roughness of a particle surface by comprising such a matting agent with no wax coating.

In addition, when coated on the surface of an injection mold, the coating layer composition, in embodiments, does not peel off even after high-repetition injections and exhibits improved lifespan characteristics. This will be described below along with experimental examples.

In embodiments, the matting agent is included in an amount of 3 to 5 weight % based on the total weight of the coating layer composition for the injection mold. If the weight of the matting agent is included less than this range, the matting effect, in embodiments, is reduced. If the weight of the matting agent is included exceeding this range, the durability of the entire composition, in embodiments, is reduced. Therefore, the above range may be preferable in embodiments.

Meanwhile, in embodiments, the coating layer composition for an injection mold according to the present disclosure comprises an additive. In embodiments, the additive comprises reaction catalysts, curing agents, fillers, or the like.

In embodiments, reaction catalysts control the curing rate or improve reactivity to secure the strength of the coating layer. However, these are not limited to any one type, and any commercialized reaction catalyst that can be included in the coating layer composition for an injection mold may be used.

In embodiments, curing agents strengthen chemical bonds during the curing process of the coating layer composition. For example, in embodiments, epoxy-based curing agents are used, but the curing agents are not limited to these, and any commercialized curing agent that can be included in the coating layer composition for an injection mold may be used.

The additives of the present disclosure are not limited to the above substances, and various additives can be combined according to the characteristics required for the coating layer, such as heat resistance, wear resistance, corrosion resistance, strength, and the like.

In embodiments, an injection mold according to the present disclosure comprises a coating layer comprising the coating layer composition for an injection mold according to various embodiments described above and a cavity area.

Here, the cavity area refers to a space located on one side or one face of the mold, which is filled with injected molten plastic to create the shape of the product.

In embodiments, the coating layer is formed to cover at least a portion of the cavity area.

In embodiments, the coating layer is formed by applying a coating material comprising the various coating layer compositions to the cavity area, and then undergoing a curing process.

In embodiments, the curing process is carried out through oven drying. In embodiments, oven drying refers to a process of curing at a constant and uniform temperature by heating the air inside an oven.

In embodiments, a coating layer formed in this way is positioned on the cavity area of the mold to have certain adhesion and heat resistance, improving the wear resistance of the mold. In addition, by lowering the coefficient of friction, the durability of not only the mold but also the injection-molded product is improved.

In embodiments, the coating layer has a gloss of 0.5 to 0.7 as measured by a 60° gloss meter. In embodiments, the gloss is about 0.6. The 60° gloss meter refers to equipment for measuring the gloss of an object's surface, where 60° indicates the measurement angle, and the gloss may be calculated by irradiating light onto the surface at this angle and measuring the amount of light reflected.

In embodiments, the coating layer has a surface roughness of 1.5 to 1.9 μm.

In embodiments, the coating layer has a thickness of 15 to 30 μm.

Meanwhile, according to an embodiment of the present disclosure, embossing is formed on at least a portion of a surface of the cavity area. Here, embossing refers to grain, which means fine patterns or textures formed on the mold surface. It may also refer to embossing that has undulations, unevenness, or recessed forms on the mold surface.

That is, in embodiments, the cavity area of the present disclosure comprises embossing including a convex part that is a protruding part and a concave part that is a recessed part. Here, the convex and concave parts are not limited to specific shapes or depths, and may have various shapes depending on the required shape of the injection-molded product.

In one example, the embossing has a concave depth of about 100 to 140 μm. Here, the concave depth refers to the height of the deepest part in the concave part of the embossing.

In one example, the cavity area comprises two or more different types of embossing. For example, one portion of the cavity area comprises embossing in the form of a stipple, while another portion may comprise a leather pattern with a larger grain.

Meanwhile, the coating layer of the present disclosure described above, in embodiments, is formed with a uniform thickness along the undulations or unevenness of the embossing formed on the surface of the cavity area.

In embodiments, the injection mold according to the present disclosure comprises the coating layer composition described above. In embodiments, the coating layer is formed along the embossing of the cavity area, thereby having improved heat resistance. In addition, even after repeated injection processes, the coating layer, in embodiments, does not peel off from the injection mold, resulting in improved lifespan characteristics.

In embodiments, the coating layer of the present disclosure does not peel off from the injection mold even after 1000 repetitions of injection.

In embodiments, for the injection mold of the present disclosure, injection processes is performed not only for polypropylene (PP) but also for various plastics.

For example, injection processes are performed for plastics comprising at least one selected from of polypropylene (PP), polyamide (PA), acrylonitrile-butadiene-styrene (ABS), and polybutylene terephthalate (PBT). In embodiments, injection processes is be performed for plastics that further comprise glass fiber (GF) in the above plastics. Therefore, the injection mold according to the present disclosure has wide versatility as it can be applied to various molten plastics compared to existing injection molds.

In embodiments, for an injection-molded product manufactured using the injection mold according to an embodiment of the present disclosure, the gloss is 1.5 or less as measured by a 60° gloss meter. Through this, lower gloss implementation and adjustment are possible compared to injection-molded products manufactured using existing injection molds.

Such low-gloss injection-molded products can be used as automotive interior parts.

Hereinafter, the present disclosure will be described in more detail by means of examples. However, the following examples and experimental examples are provided merely to describe the present disclosure in more detail, and the scope of the present disclosure is not limited by the following examples and experimental examples.

### Example 1

To prepare a coating material comprising the coating layer composition for an injection mold according to the present disclosure, a high-heat-resistant resin and a matting agent were mixed. Polytetrafluoroethylene (PTFE) was used as the high-heat-resistant resin, and HK-125 matting agent from Evonik, which comprises spherical silica (SiO₂) with a particle diameter of 10 μm that is not coated with wax, was used as the matting agent and mixed. Here, the matting agent was used at 3 weight % based on the total composition.

### Example 2

An injection mold was prepared for applying the coating layer coating material according to Example 1. The injection mold used had a leather pattern embossing of Kia's emboss code KM-185 formed on half of the surface of the cavity area, and a leather pattern embossing of Kia's emboss code KM134-1 (or KM134-1 AF) formed on the other half.

The previously prepared coating layer coating material was applied along the embossing formed on the surface of the cavity area of the injection mold. Thereafter, a coating layer was formed on the injection mold by going through a curing process via a drying oven.

The coating layer formed in this way was formed with a thickness of about 20 μm along the embossing formed on the surface of the cavity area, had a surface roughness of about 1.7 μm, and a gloss of about 0.6 as measured by a 60° gloss meter.

### Comparative Example 1

To prepare a coating material comprising a coating layer composition for an injection mold, a high molecular weight acrylic base was used. No additional matting agent was used.

### Experimental Example 1

In this experiment, test molds were coated with coating layer compositions comprising the coating materials of Example 1 and Comparative Example 1 to prepare respective injection molds. Kia's KM134-1 was used as the test mold. (Hereinafter, the respective injection molds are simply referred to as Example 1 and Comparative Example 1.)

Thereafter, polypropylene (PP) was used as the injection plastic for each injection mold, and injection was repeatedly performed more than 300 times.

During that process, the wear distance, degree of wear on the test mold, and the point of peeling of the coating layer were first observed.

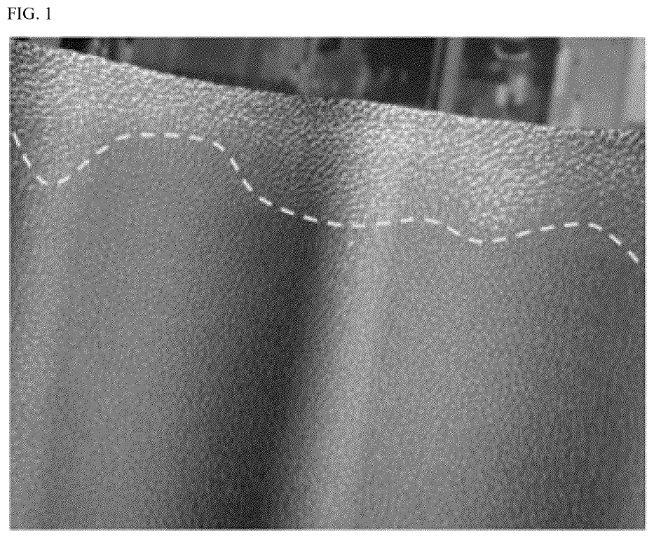

FIG. 1 is an image showing the appearance of Comparative Example 1 after repeated injections. (The dotted line in FIG. 1 indicates the observed wear distance.)

Referring to FIG. 1, for Comparative Example 1, wear was observed at a distance of 20 to 45 mm from one end of the mold, and scratches were observed at a draft angle of 5 degrees or less. In terms of the degree of wear, 60 to 80% wear occurred.

Meanwhile, for Comparative Example 1, peeling began to be observed from the 300th repetition of injection. Comparative Example 1 showed relatively short mold lifespan characteristics. This can be understood as due to the composition of Comparative Example 1, where the use of an acrylic base resulted in a reduced ability to disperse surface wear, leading to a short mold lifespan and a large degree of observed wear.

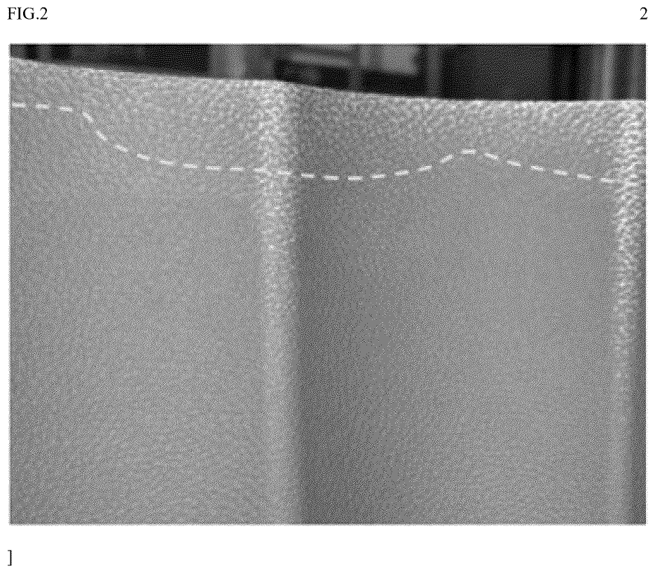

FIG. 2 is an image showing the appearance of Example 1 after repeated injections. (The dotted line in FIG. 2 indicates the observed wear distance.)

Referring to FIG. 2, for Example 1, wear was observed at a distance of 10 to 30 mm from one end of the mold, and scratches were observed at a draft angle of 3 degrees or less. In terms of the degree of wear, 40 to 70% wear occurred, confirming that there was less wear on the mold compared to Comparative Example 1.

Meanwhile, for Example 1, peeling was observed after 1000 repetitions of injection. The appearance of the peeled coating layer confirmed that Example 1 was significantly superior to Comparative Example 1 not only in terms of the degree of wear but also in mold lifespan characteristics. This result can be attributed to the composition in the coating layer of Example 1, and it can be expected that it can reduce mold wear not only in test molds but also in various actual injection molds.

### Experimental Example 2

In this experiment, various plastics were injection-molded using the injection mold according to Example 2 to produce vehicle seat back molded articles. Thereafter, the gloss of the injection-molded products was measured using a 60° gloss meter.

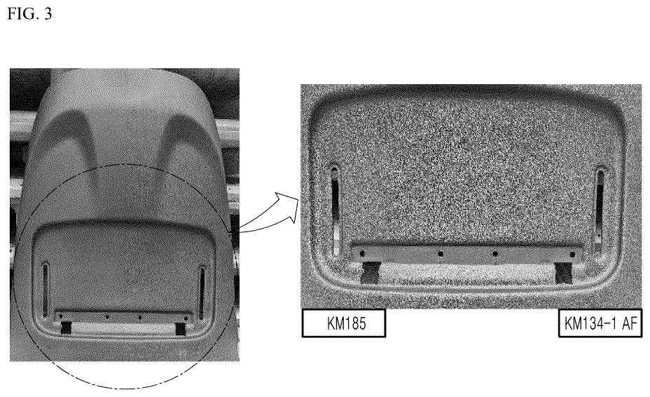

First, polypropylene (PP) containing 15% glass fiber was used for injection, and the manufactured injection-molded product is shown in FIG. 3. The gloss of the injection-molded product produced from the side where KM-185 embossing was formed was 1.2, and the gloss of the injection-molded product produced from the side where KM134-1 embossing was formed was measured as 1.4.

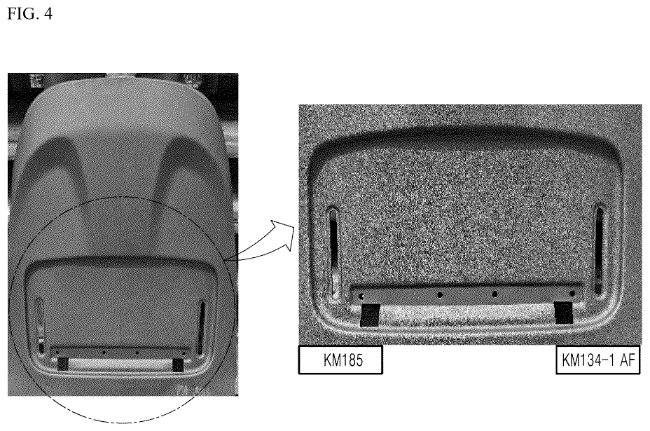

Next, a mixture of polyamide (PA) and acrylonitrile-butadiene-styrene (ABS) was used for injection, and the manufactured injection-molded product is shown in FIG. 4. The gloss of the injection-molded product produced from the side where KM-185 embossing was formed was 1.1, and the gloss of the injection-molded product produced from the side where KM134-1 embossing was formed was measured as 1.2.

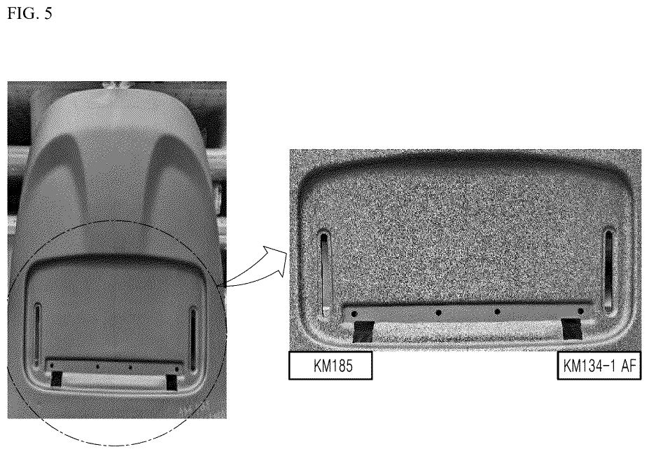

A mixture of acrylonitrile-butadiene-styrene (ABS) and (polybutylene terephthalate (PBT) was used for injection, and the manufactured injection-molded product is shown in FIG. 5. The gloss of the injection-molded product produced from the side where KM-185 embossing was formed was 0.9, and the gloss of the injection-molded product produced from the side where KM134-1 embossing was formed was measured as 1.0.

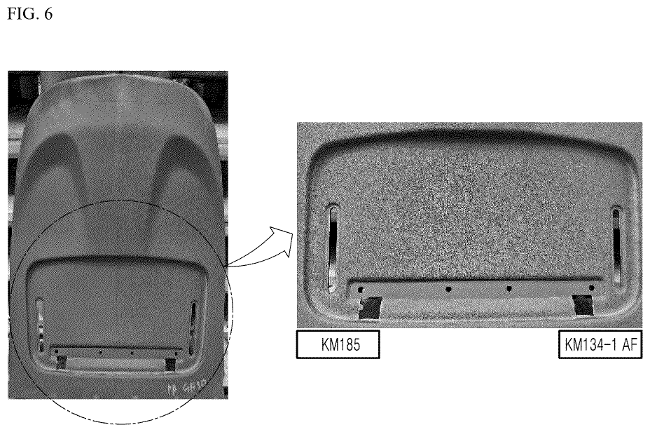

Polyamide (PA) containing 30% glass fiber was used for injection, and the manufactured injection-molded product is shown in FIG. 6. The gloss of the injection-molded product produced from the side where KM-185 embossing was formed was 0.5, and the gloss of the injection-molded product produced from the side where KM134-1 embossing was formed was measured as 0.6.

As a result of conducting injections of various plastic materials using the injection mold comprising the coating layer according to the present disclosure, it can be seen that the appearance quality is enhanced, as shown in FIGS. 3 to 6. Also, as described above, all glosses were measured to be 1.5 or less as measured by a 60° gloss meter, confirming that it is possible to adjust the gloss of interior materials, including vehicle seat backs, to achieve low gloss.

The present disclosure has been particularly shown and described with reference to embodiments thereof. In this regard, it will be understood by one of ordinary skill in the art that various changes in form and details may be made therein without departing from the scope of the disclosure. Therefore, the disclosed embodiments should be considered in a descriptive sense only and not in a limiting sense. The scope of the disclosure is defined not by the detailed foregoing description but by the following claims, and all differences within the scope will be construed as being included in the disclosure.

What is claimed is:

1. A coating layer composition for an injection mold, the coating layer composition comprising:
a high-heat-resistant resin; and
a matting agent with no wax coating.

2. The coating layer composition for an injection mold of claim 1, wherein the high-heat-resistant resin is polytetrafluoroethylene (PTFE) or polyetheretherketone (PEEK).

3. The coating layer composition for an injection mold of claim 1, wherein the matting agent comprises spherical silica (SiO₂).

4. The coating layer composition for an injection mold of claim 3, wherein the matting agent has a particle diameter of 7 to 15 μm.

5. The coating layer composition for an injection mold of claim 1, wherein the matting agent is included in an amount of 3 to 5 weight % based on a total weight of the coating layer composition for the injection mold.

6. An injection mold comprising:
a cavity area; and
a coating layer comprising the coating layer composition for an injection mold of claim 1, wherein the coating layer is formed to cover at least a portion of the cavity area.

7. The injection mold of claim 6, wherein the coating layer has a gloss of 0.5 to 0.7 as measured by a 60° gloss meter.

8. The injection mold of claim 6, wherein the coating layer has a surface roughness of 1.5 to 1.9 μm.

9. The injection mold of claim 6, wherein the coating layer has a thickness of 15 to 30 μm.

10. The injection mold of claim 6, wherein embossing is formed on at least a portion of a surface of the cavity area.

11. The injection mold of claim 10, wherein the embossing has a concave depth of 100 to 140 μm.

12. The injection mold of claim 10, wherein the coating layer is formed with a uniform thickness along the embossing formed on the surface of the cavity area.

13. The injection mold of claim 6, wherein the coating layer does not peel off after 1000 repetitions of injection.

14. The injection mold of claim 6, wherein an injection-molded product formed by the injection mold has a gloss of 1.5 or less as measured by a 60° gloss meter.
